(19) United States
(12) Patent Application Publication
(10) Pub. No.: US 2009/0265414 A1
(43) Pub. Date: Oct. 22, 2009

(54) Mechanisms for transparently converting client-server software agents to peer-to-peer software agents

(76) Inventor: David A. Bryan, Williamsburg, VA (US)

Correspondence Address: LUMEN PATENT FIRM, 350 Cambridge, Suite 100, PALO ALTO, CA, 94306, US

(21) Appl. No.: 12/313,609

(22) Filed: Nov. 21, 2008

Related U.S. Application Data
(60) Provisional application No. 61/004,900, filed on Nov. 29, 2007.

(51) Int. Cl. G06F 15/16

(52) U.S. Cl. 709/202

(57) ABSTRACT

A method of converting client-server software agents to peer-to-peer software agents coupling a client to an adaptor software module is provided. The method includes directly coupling a client in software to an adaptor software module, wherein said adaptor software services underlying traffic from an unmodified agent and relays it on behalf of said unmodified agent, wherein all traffic generated by said unmodified agent is relayed directly to said adaptor software module.

### CROSS-REFERENCE TO RELATED APPLICATIONS

This application claims priority from U.S. Provisional Patent Application 61/004900 filed Nov. 29, 2007, which is incorporated herein by reference.

### FIELD OF THE INVENTION

The invention relates generally to distributed software systems. More particularly, the invention relates to a client directly coupling in software to an adaptor software module that services underlying traffic from the unmodified agent and relays it on behalf of the agent, and rather than the agent using a network connection to the adaptor, all traffic generated by the agent is relayed directly to the adaptor software module.

### BACKGROUND

In distributed software systems, agents, also often called endpoints, devices, or user agents, communicate with each other or with central devices. For example, an agent may both send and receive information, such as in a telephone-like device, or file/media sharing application, an agent may receive (or request and receive) information only, such as in a television-like device, a web client, or streaming media viewer agent, or an agent may transmit information only, such as with a camera that is only able to stream information to a central server for others to obtain.

These agents may be in the form of a software application, a hardware device, or a hardware device running a software application which implements the agent. The agent may have a user associated with it, for example in the case of a phone or mail system where the agent processes messages for a particular user's number or address, or it may operate without an associated agent.

In traditional client-server (CS) architecture, agents use a centralized server, which acts on behalf of that agent. The behaviors or services that the central server may provide to the agent include, but are not limited to: registration, or storing a mapping of the agent's user's unique name to location; presence information, or information about the agent's users availability, desire to be disturbed, etc.; locating a remote agent and proxying messages to that agent; locating a remote agent and referring or redirecting the agent to that party (often referred to as “discovery” or “rendezvous” capability; storage and/or distribution of information used by applications (such as web pages, media files, documents, etc.); storage and/or distribution of information such as configuration information; storage and/or distribution of information such as system warning or downtime information; storage and/or distribution of information related to system or software updates; storage of and/or distribution of messages in text, audio, video, or other form for later retrieval or deliver; providing security and asserted identity between various communicating parties; storing and delivering messages for a user who is unavailable; providing interactive voice response mechanisms; and providing information about resources stored by the remote agents and how to retrieve the information from the remote agents.

In a P2P communications system, one, more, or all of the functions that would normally be performed by a centralized server are instead performed by a distributed group of the agents themselves, working together to collectively provide the service. In such cases some aspects of communications between the agents may be identical to the behavior of an agent connecting to the central server, however, one or more critical aspects will differ in that the distributed group of agents performs a task that would otherwise require a central server.

As just one example, in Session Initiation Protocol (SIP), locating a remote party in a CS model involves several steps. At a high level, an agent wishing to make themselves available for communications first registers, or sends a message or messages to a central server providing the location (IP address or other information required to route information) of the agent and a well known name or address of record that refers to that agent's user. When calling agents wish to locate another agent, they either send requests to the central agent asking for the location of the remote agent, or send a message intended for the remote agent to the server, allowing it to route or redirect the message so that it reaches the appropriate destination.

In a P2P model, registrations (the mappings between the well known name and location) are instead sent to one or more of the other agents that make up the distributed group of agents. These agents, collectively, maintain the mappings that would normally be maintained by the server. Calling agents contact and work with one or more other agents (dependent upon the exact nature of the P2P algorithm) to locate the agent that is storing the registration. One or more intermediate agents or data provided by one is thus used to locate and communicate with the remote party's agent, rather than a central server.

P2P mechanisms exist to distribute many of the services enumerated above.

Because this alternate location mechanism (or any other mechanism beyond location that is distributed among the end agents, rather than a central server) generally requires modified behavior in the end agent, implementers wishing to create a P2P system have to date been presented with a small number of choices. These choices include implement a completely new agent, making calls to other agents and following the P2P algorithm, rather than contacting a central server directly; significantly modify an existing agent to make calls to other agents following the P2P algorithm, rather than contacting the central server directly; and use a separate, standalone “adaptor node” agent to receive the calling agent's CS protocol, and make new P2P protocol calls on the calling agent's behalf.

Implementing or modifying an agent has a number of shortcomings. It requires significant new engineering effort. It cannot immediately leverage all work on existing agents, since current agents require modification to operate. Finally, work done to modify one application client in no way improves the performance of other applications—each must be modified separately to perform the operations in a distributed fashion.

Because of these shortcomings, a standalone adaptor agent, often called an adaptor node or adaptor peer, has been attempted. Such an adaptor agent runs as a member of the P2P network of agents. One or more unmodified agents are explicitly configured to connect to the adaptor agent over a network connection. This network connection may be external (between two physical machines) or internal, using the machine's virtual machine loopback, system socket mechanism, or similar network-like mechanism. The adaptor node acts as a central server in the view of the unmodified agent, but participates as a full P2P agent in the distributed group of peers.

For some applications, this mechanism works to allow unmodified CS agents to connect to the P2P network, but there a significant number of problems with this approach, as well as cases where it fails. Some examples of the problems include certain protocols allowing for agents to initiate connections directly with other agents when the location of these have already been determined. In such cases, it may be difficult to ensure that the unmodified CS agent does not become confused and try to communicate directly with P2P agents. Failure to use the adaptor agent for all communications can result in the state information that needs to be stored by the P2P networking being incomplete or corrupted, or result in one or the other agents receiving messages they are unable to understand or process. A further problem is with most newer protocols, including the P2P protocols to which this concept applies, are being designed with increased security. Since the older protocol is being used between the unmodified agent and the adaptor node, possibly traveling over an unsecured network or on a virtual network inside a multi-user machine, the advantages of the newer security mechanisms are not realized. Another problem is that if the adaptor agent is located on a different host than the calling agent, the calling agent cannot function properly if the host with the adaptor agent fails. In the event both operate on the same host, the agent cannot operate in the case that the adaptor node application crashes. There may be no good mechanism for the agent to restart, or even observe that the adaptor node has failed. Additionally, because the proper function of this system requires the agent to be configured to communicate with the adaptor node, this mechanism is susceptible to misconfiguration.

Accordingly, there is a need to provide a mechanism where a client is directly coupled in software to an adaptor software module that services underlying traffic from the unmodified agent and relays it on behalf of the agent. What is further needed is, rather than the agent using a network connection to the adaptor, all traffic generated by the agent is relayed directly to the adaptor software module.

### SUMMARY OF THE INVENTION

A mechanism is provided where a client is directly coupled in software to an adaptor software module that services underlying traffic from the unmodified agent and relays it on behalf of the agent. Rather than the agent using a network connection to the adaptor, all traffic generated by the agent is relayed directly to the adaptor software module.

According to one embodiment, the invention includes a method of providing a protocol stack, state machine, protocol library, dialog manager, or application driver for the new P2P protocol with exactly or substantially similar function signatures to the older, non-P2P protocol the CS agent is built using. In one aspect, the application requires little or no modification, since the function calls are essentially identical. Internally to the stack, however, these commands are translated to the new protocol, and activities such as lookup, storage of information, etc. are performed by the underlying stack in a P2P manner, with the result being passed back to the calling agent application in exactly the same format as if it were received from a server. In another aspect, the existing application may have inferior security properties, but the new stack will use the newer, superior security properties. In a further aspect, the existing application can function only in CS mode, or with combination with the adaptor software module, it can join the P2P network. In another aspect of the current embodiment, the new stack or software may or may not provide a configuration mechanism to allow configuration of parameters that are specific to the new protocol and the adaptor software module. In a further aspect, the new stack may additionally provide some new functionality, allowing the client developer to add new features to the agent over time, but the critical point is that an interface substantially like the existing one is provided to allow agent applications to be ported with little or no modification.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

We instead provide a mechanism where a client is directly coupled in software to an adaptor software module that services underlying traffic from the unmodified agent and relays it on behalf of the agent. Rather than the agent using a network connection to the adaptor, all traffic generated by the agent is relayed directly to the adaptor software module.

According to one embodiment, the invention includes a method of providing a protocol stack, state machine, protocol library, dialog manager, or application driver for the new P2P protocol with exactly or substantially similar function signatures to the older, non-P2P protocol the CS agent is built using. In one aspect, the application requires little or no modification, since the function calls are essentially identical. Internally to the stack, however, these commands are translated to the new protocol, and activities such as lookup, storage of information, etc. are performed by the underlying stack in a P2P manner, with the result being passed back to the calling agent application in exactly the same format as if it were received from a server. In another aspect, the existing application may have inferior security properties, but the new stack will use the newer, superior security properties. In a further aspect, the existing application can function only in CS mode, or with combination with the adaptor software module, it can join the P2P network. In another aspect of the current embodiment, the new stack or software may or may not provide a configuration mechanism to allow configuration of parameters that are specific to the new protocol and the adaptor software module. In a further aspect, the new stack may additionally provide some new functionality, allowing the client developer to add new features to the agent over time, but the critical point is that an interface substantially like the existing one is provided to allow agent applications to be ported with little or no modification.

While each P2P protocol that is being translated to is slightly different, in general this system is implemented as follows. In a structured P2P system, systems are uniquely identified, and are located based upon P2P identifier (ID) (such as a peer or node ID), which are either used in place of, or in addition to, traditional network routing primitives such as IP addresses, Ethernet addresses, etc. This mechanism works by receiving calls from the protocol stack, state machine, protocol library, dialog manager or application driver, which appear identical to the traditional calls. Once received, the underlying code is responsible for making a number of modifications/translations to the message (if passed as a complete message) or to encode it in a different way than the unmodified library would have. In both cases, this is done before any information is sent over the wire or to a low-level socket library. These modifications may include one or more of the following. Note that these modifications are quite different than those that would be applied when translating between two different CS protocols.

An exemplary translation may include messages that are being sent out in a P2P or overlay network in many cases require a P2P identifier. If this is the first message being sent, an identifier must be obtained, either by local generation (for example hashing a unique property), protocol based mechanisms to request an ID from the other peers, or out of band mechanism for requesting an ID. This ID may or may not also provide cryptographic assertion of identity.

Another translation example may include a case when all messages sent after an ID is obtained (including the first message sent) may need to include this ID. The modified protocol stack, state machine, protocol library, dialog manager, or application driver will insert this ID into the messages. Received messages may need to have information added to support this stripped or translated before being passed back to the unmodified application. Additionally, the messages may need to be made to appear to have originated from the desired target of the CS protocol.

A further translation example can be where message routing in structured P2P systems often involves performing a lookup, and using the returned network location as the destination of the message. As such, the modified protocol stack, state machine, protocol library, dialog manager, or application driver must perform this lookup, and if required by the particular P2P protocol being used, place this information into headers to route the message, rather than the more traditional mechanisms that may be used in a CS protocol, such as DNS resolution or sending directly to an embedded IP address. Received messages may need to have information added to support this stripped or translated before being passed back to the unmodified application. Additionally, the messages may need to be made to appear to have originated from the desired target of the CS protocol.

In another translation example, messages routed in a structured P2P network also may need to be sent through an intermediary, determined by the underlying P2P network. This could be for topological routing considerations, NAT traversal, obfuscation/anonymity of the messages, or simply because the particular P2P protocol used requires such an intermediary be used. As such, the modified protocol stack, state machine, protocol library, dialog manager, or application driver will determine which other peer it is appropriate to use to relay the message, marking and routing the request appropriately as needed. Received messages may need to have information added to support this stripped or translated before being passed back to the unmodified application. Additionally, the messages may need to be made to appear to have originated from the desired target of the CS protocol.

In a further translation example, some P2P protocols may require unique signatures or encryption properties, for example ones that sign or encrypt information as being from a particular peer. This may require fetching of the appropriate information (certificates or other information) needed to encrypt or decrypt messages from other peers on the fly, so they can be translated and passed back to the unmodified application.

Additionally, messages of different types may be treated differently in different protocols. For example, in some CS telephony applications, messages providing location, controlling features, storing voicemails, and setting up calls, may all be sent to different devices—registration servers, feature servers, voicemail servers, and call control servers. In a P2P system, all of these features may be distributed among the peers, and require appropriate lookup to route to a peer with those capabilities. Similarly, a CS system may require all messages to be sent to one location, and again a P2P system may distribute the functions among the peers, requiring lookup of locations before transmitting, or storing information.

In an unstructured P2P system, IDs may not be present, but techniques such as broadcasts or flooding the network may be used to locate an appropriate host for messages to be sent to, and appropriate routing information based on these P2P responses will need to be inserted on outbound messages, and stripped from inbound messages. The modified protocol stack, state machine, protocol library, dialog manager, or application driver will also need to then route messages to the appropriate peer, based on these unstructured searches. Received messages may need to have information added to support this stripped or translated before being passed back to the unmodified application. Additionally, the messages may need to be made to appear to have originated from the desired target of the CS protocol, just as ID based information would need to be in a CS to structured P2P translator.

These types of translations are fundamentally different from the type of translations—often little more than converting an address or transcoding packets from one protocol to another—that are offered by traditional CS to CS translations.

In one aspect, if there are several agent applications, each of which uses a stack, modifying a single stack may not allow all the agents to transparently use the new protocol. As such, deep packet inspection techniques may be used instead. In such a case, the client application is built against a modified low-level data connection library (for example a socket library or equivalent), rather than the traditional system low-level data connection library. Unlike an adaptor agent, the raw messages are not passed over a network or within the computer as virtual messages across the loop back or system sockets, but are rather intercepted by a modified interface library. This library performs deep packet inspection, examining each packet to see if it is using the older, CS protocol. Packets that are not the older protocol are passed unmodified to the network connection, while packets from the older CS protocol are instead processed, and P2P packets inserted on the network connection as needed. The modified low-level data connection is used to pass back information to the calling program that appears to have come from the network and to have been processed in a client-server fashion. In some cases there may not be a one-to-one mapping between the old packets and new packets. As such, the modified low-level data connection library may send and receive messages on the wire at a different rate or with different payloads than those passed back and forth between the modified data connection library. This allows for translation even in cases where the new P2P protocol differs radically from the client-server protocol.

Implementing such an application would be similar to the changes discussed above. The primary difference is where this code is implemented. In the embodiment above, this lies in the modified protocol stack, state machine, protocol library, dialog manager, or application driver, which has a signature similar to the unmodified one, and in general is an application level software implementation. In this embodiment, the application level protocol stack, state machine, protocol library, dialog manager, or application driver is left intact, but the messages it produces are intercepted at a low level before being placed on the wire. These messages are then translated in place. The application is unchanged, and is even linked to an unmodified protocol library—the translation occurs to the messages at a low level before they are placed on the wire. When used before, this mechanism of deep packet inspection has been used to intercept and redirect messages to a different, but usually fixed location, to translate messages from CS protocol to another, or to translate internal addresses to traverse a NAT. In general, run time decisions about where messages are routed are not made. In this case, the unique properties of a P2P network (including as discussed above, choosing where to route messages, marking them appropriately for an overlay, performing broadcasts, etc.) make the type of translation performed quite different. Packets that are not to be translated or are unrelated to the new P2P protocol are untouched.

Unlike an agent combined with an adaptor agent, in this approach, there is a single resulting software entity and messages are not passed over a network connection (either physical or virtual internal such as a loopback or system socket). No traffic in the older protocol can be transmitted, ensuring that messages are not inadvertently sent in a non-P2P fashion, using the older security etc.

The mechanism discussed above is unlike the adaptor node previously attempted in the sense that the agent is not explicitly aware of the connection to an adaptor. In the adaptor node scenario, the agent is explicitly configured to talk to the adaptor just as if it were a server. In this approach, the code is recompiled against the adaptor software module, which hides the translation in any way from the higher-level agent. Additionally, this mechanism does not require packets to pass over a virtual network connection (although as noted below, and alternate embodiment where this does occur is mentioned).

In all of the mechanisms discussed above, the low-level change could additionally switch back and forth in behavior between translating, thus producing a P2P application, and not translating the underlying packets, allowing the application to operate in both P2P and CS modes, without modification to the application.

According to another embodiment, one could have the deep packet code not being compiled or linked with the agent software as described above, and not sitting in the low level socket code of the source machine, but instead sitting in a NAT, firewall, router, gateway or any other device that sets in the network, in particular, at the interface between a local network and a wider area network such as the internet. All traffic flowing through the agent would be inspected for client server traffic, which could be transparently converted to P2P traffic. This would require the ability for an administrator to configure the edge box, but would allow all agents behind the network to switch over to the new P2P protocol as seen by the outside world, without the agents even being aware this had happened. This provides the opportunity for providers/managers to transition enterprises or organizations in a nearly seamless way. This would be implemented as deep packet inspection, as discussed in the embodiment above, but with the traffic now flowing over a wire unmodified until it reaches the network element, where this rewriting will occur. Note that while such rewriting has been done to fix addresses within a protocol while traversing NATs and to translate from one protocol to another, the unique nature of the changes required to convert to P2P from CS, as outlined in embodiment (1) above, make this a unique application of deep packet inspection technology.

This transparent deep packet inspection behavior could also be placed in operating system software, such as a system wide firewall. In such a case, all applications running on the host would be converted, again without modification to the agents.

Similarly, the behavior could be implemented directly in the OS low-level data connection library itself, meaning all applications using the network connection would be translated.

Packet inspection and modification behavior is often implemented in firewalls, NATs, or Session Border Controllers (SBCs), however such behavior has to date not been used to convert between different protocols or between P2P and non-P2P protocols.

Note that this mechanism can additionally be used to translate between CS and P2P versions of the same protocol, where appropriate, or even to translate messages from multiple CS protocols into a single P2P protocol.

In this invention, the agent is compiled against a modified library, which presents the same interface to the developer, but performs P2P operations in the background. The agent requires no separate adaptor, as it is directly coupled at a software level to the adaptor software module that performs the P2P operations, by intercepting at a very low level (socket or data connection level, intercepting the messages that would be sent across the network) or at a higher level (stack, state machine, application) to translate the traffic to P2P traffic.

Similarly, an adaptor could be transparently inserted into an edge agent in the network, or within an OS network component (low level data interface, firewall, etc.) that uses deep packet inspection to intercept and translate messages from the agents before they are fed onto the Internet. This differs from the proposed adaptor node in that such interception and modification of traffic is transparent to the agent, rather than requiring the agent to be “pointed” at an adaptor that serves on the behalf of the agent. This also allows installations to be translated from one protocol to another in place.

The edge agent resident approach described above differs from the SBCs deployed today in that the inspection mechanism is used to fundamentally alter the behavior of the agents behind from speaking to a client-server oriented protocol to speaking to one that is peer to peer. To date, SBCs have been used mostly to enforce security or to modify the IP addresses embedded in messages to allow the traffic to traverse NATs, or to translate between one CS protocol and another. Today, these devices mostly translate between two versions (often proprietary) of a single CS protocol, or between two different CS protocols. Additionally, they are used to modify protocols to pass NATs, insert additional security, etc. To date, we know of no use to translate between CS and P2P protocols, or between CS and P2P versions of one protocol.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed:

1. A method of converting client-server software agents to peer-to-peer software agents coupling a client to an adaptor software module comprising:
a. directly coupling a client in software to an adaptor software module, wherein said adaptor software services underlying traffic from an unmodified agent and relays it on behalf of said unmodified agent, wherein all traffic generated by said unmodified agent is relayed directly to said adaptor software module.
